(19) United States
(12) Patent Application Publication
(10) Pub. No.: US 2021/0170351 A1
(43) Pub. Date: Jun. 10, 2021

(54) METHOD FOR PRODUCING COATING AGENT COMPOSITIONS OR PRECURSORS THEREOF THAT CAN BE USED IN THE AUTOMOBILE INDUSTRY

(71) Applicant: BASF Coatings GmbH, Münster (DE)

(72) Inventor: Alexander Blaser, Münster (DE)

(21) Appl. No.: 17/048,741

(22) PCT Filed: Apr. 23, 2019
(86) PCT No.: PCT/EP2019/060262

§ 371 Date: Oct. 19, 2020

(30) Foreign Application Priority Data
Apr. 24, 2018 (EP) 18168966.2

(51) Int. Cl. B01F 15/00; B01F 13/10

(52) U.S. Cl. CPC B01F 15/00194; G01G 19/346; B01F 13/1066

(57) ABSTRACT

Described herein is a method for producing a coating medium composition usable in the automobile industry, or a precursor thereof, the method including (1), providing a container, which has a label that contains the formula of the target formulation in electronically readable form (2), electronically reading the label (3), providing storage containers containing those components which are required in order to produce the target formulation (4), weighing these components into the containers provided (5), creating an electronic log relating to the weighing-in carried out (6) and creating an electronic documentation of the entire production process (7), wherein the conduct of steps (3), (5) and (6) is carried out by means of assistance by software.

The present invention relates to a method for producing a coating medium composition usable in the automobile industry, or a precursor thereof, the method comprising at least steps (1) to (7), namely creating a formula of a target formulation or retrieving such an existing formula from a database (1), providing a container, which has a label that contains the formula of the target formulation in electronically readable form (2), electronically reading the label (3), providing storage containers containing those components which are required in order to produce the target formulation (4), weighing these components into the containers provided (5), creating an electronic log relating to the weighing-in carried out (6) and creating an electronic documentation of the entire production process (7), wherein the conduct of steps (3), (5) and (6) is carried out by means of assistance by software, this assistance comprising monitoring of the weighing-in according to step (5), the formula containing, for each of the components which is weighed in in (5) in order to produce the target formulation, a predefined error tolerance range in relation to its weighing-in quantity, and the weighing-in of the components in (5) is therefore carried out in the scope of their respective predefined error tolerance ranges.

### PRIOR ART

The first stage in the development of coating medium compositions usable in the automobile industry usually takes place in research laboratories. Even in modern coatings development laboratories and coatings customer laboratories, the production of such compositions or precursors thereof, for example pigment pastes or effect pigment pastes are carried out by means of a sequence of similar process steps, i.e. without superordinate automated process monitoring. This also includes the weighing-in of the individual components used therefor and monitoring of their storage stock and their procurement.

Even in modern coatings laboratories, the weighing-in of the components respectively used is generally carried out by means of a balance which is not EDP-networked, in combination with the use of a laboratory book into which the setpoint values of the weighing-in of the individual components as well as the actual values after the weighing-in are entered by hand. This procedure is, inter alia, due to the fact that the existing process control systems in companies of the chemical industry are usually oriented primarily toward the requirements of mass production but not to the requirements of coatings laboratories, which are usually very different than these.

The functional scope of process control systems, including a technique of weighing-in, is therefore tailored to the large industrial scale, and because of this cannot always satisfactorily accommodate the specific requirements of coatings laboratories, and to date is also not readily adaptable and usable for the laboratory scale used therein. The reasons for this are on the one hand the substantially greater complexity and range of variation in such coatings laboratories and the conduct of comprehensive series of tests compared with mass production of individual large batches. On the other hand, the substantially smaller sample quantities which are used in coatings laboratories also play a considerable role.

The result of this is that all attempts to date at optimizing laboratory processes, for example by means of software-based solution approaches, are often already exhausted with the creation of tabular formula printouts. In this case, experimental tables are first generated, usually with generally available software such as Microsoft Excel®, these are subsequently printed out by the laboratory coworker and the respectively intended components are weighed in successively on the basis of these printouts, and the respectively weighed-in positions are checked off on the printout. Care of the tabular experimental recording, i.e. documentation of the experimental history, is subject to the individual responsibility of the laboratory worker, but at most it is subject to in-laboratory specifications. A qualitative evaluation of the setpoint values and the actual values of the weighed-in formula constituents usually does not take place in this case. Recording of the raw material batches used also usually does not take place.

With the usual analog working procedure of the laboratory coworker when weighing-in the components, no monitoring of the accuracy of the weighing-in takes place, i.e. the setpoint values with the actual values of the weighing-in are not evaluated in relation to one another and compared against a specific tolerance specification. Furthermore, compliance of the order of the weighing-in of the components is neither monitored, nor is it ensured that all formula positions have actually been weighed in and none has been forgotten (or it has only been forgotten to mark this position as weighed-in even though it has been weighed in). There are to date no standards for qualitative completion monitoring and uniform documentation of the entire preparation process in terms of the weighing-in and the allowable error tolerances.

In the course of the constantly progressing complexity of coating formulations and increasing requirements on the part of the market due to increasing of quality standards (audit conformity, quality assurance, etc.) there is therefore a need for optimization and improvement of the development processes, particularly in terms of the work carried out by the laboratory coworkers in this context in coating laboratories, such as weighing-in components for the production of coating medium compositions or precursors thereof.

Object

It is therefore an object of the present invention to provide a method for weighing-in components which are suitable for the production of a coating medium composition usable in the automobile industry or for the production of a precursor of such a coating medium composition, which has advantages over the methods of weighing-in known from the prior art. In particular, it is an object of the present invention to provide a method for producing coating medium compositions usable in the automobile industry, or precursors thereof which both provides monitoring of the setpoint values against the actual values of the weighing-in of the individual components which are required for production, and also provides maximally accurate weighing-in of the individual components, which is furthermore documentable and retrievable even in the long-term, comprehensible and usable.

Solution

This object is achieved by the subjects claimed in the patent claims, as well as the preferred embodiments of these subjects as described in the description below.

A first subject of the present invention is therefore a method for producing a coating medium composition usable in the automobile industry, or a precursor thereof, the method comprising at least steps (1) to (7), namely
(1) creating a formula of a target formulation, which corresponds to the coating medium composition to be produced or the precursor thereof, or retrieving such an existing formula from a database,
(2) providing a container, which has a label that contains the formula of the target formulation in electronically readable form,
(3) electronically reading the label of the container provided in step (2),
(4) providing storage containers containing those components which are required according to the formula in order to produce the target formulation,
(5) weighing the components provided in step (4) into the containers which are provided in step (2) and are suitable for weighing-in, the weighing-in of the components respectively being carried out in the quantities and order which are specified by the formula of the target formulation,
(6) creating an electronic log at least relating to the weighing-in carried out according to step (5), and
(7) creating an electronic documentation of the entire production process of the coating medium composition or the precursor thereof after carrying out step (6), wherein the consumption and the resulting current stock of the quantities of all components used in order to produce the target formulation are also documented and managed in the documentation created in step (7),
characterized in that at least the conduct of steps (3), (5) and (6) is carried out by means of assistance by software, this assistance comprising monitoring of the weighing-in according to step (5), the formula of the target formulation containing, for each of the components which is weighed in in step (5) in order to produce the target formulation, a predefined error tolerance range in relation to its weighing-in quantity, and the weighing-in of the components in step (5) is therefore carried out in the scope of their respective predefined error tolerance ranges.

It has surprisingly been found that the method according to the invention makes it possible to minimize errors when manually weighing-in the individual components for the production of target formulations. Weighing-in errors often arise because, although large quantities on the kg scale can be weighed in relatively exactly to the setpoint value by the person tasked with the weighing-in, i.e. without “using” a given error tolerance range of for example ±1 wt %. However, weighing-in errors often occur in smaller quantities, since the weighing-in of such components is often already terminated before the setpoint value in order to avoid overdosing. This is surprisingly avoided by the method according to the invention, and in particular by step (5), since the method according to the invention allows systematic, visually representable accuracy, which is easy to implement in practice, when weighing-in the individual components, and digitizing the previous analog and manual weighing-in technique. In this way, the compliance of the error tolerance ranges, which is absolutely necessary at latest for mass production of these formulations, is in particular taken into account sufficiently during the weighing-in even at the laboratory level when developing coating medium compositions and precursors thereof. Furthermore, besides automatic recording of the weighing-in (including the error tolerance ranges), the method according to the invention allows documentation of these steps, so that they are evaluable and retrievable, so that guidance of the laboratory coworker can take place through the entire production method.

It has furthermore surprisingly been found that the method according to the invention, in particular with additional use of optional step (7), allows digital recording and coordination of all “raw material flows” (stock management, reprocurement, consumption documentation and batch documentation, etc.), and makes it possible to monitor, represent and control all steps relevant therefor, including the raw material logistics (storage, supply, reordering, etc.).

### DETAILED DESCRIPTION

Method According to the Invention

The method according to the invention is a method for producing a coating medium composition usable in the automobile industry, or a precursor thereof. In this case, coating medium compositions which can be used both in the scope of OEM line coating and in the scope of repair coating may be produced. The same applies for corresponding precursors.

Preferably, the method according to the invention is used for the development of coating medium compositions usable in the automobile industry, or precursors thereof, preferably in laboratories such as research and development laboratories, as well as customer and service laboratories.

Preferably, the method according to the invention is therefore carried out on the laboratory scale. In the context of the present invention, this is preferably intended to mean the production of coating medium compositions, or precursors thereof, on a scale of up to 25 kg.

Coating medium compositions usable in the automobile industry are for example electro-dip coatings, primers, fillers, base coats, in particular water base coats, top coats, including clear coats, in particular solvent-based clear coats. A precursor of a coating medium composition usable in the automobile industry is preferably a pigment paste and/or filler paste. The term pigment paste in this case includes color pigment pastes and effect pigment pastes. Precursors furthermore include (temporary) semifinished products which may be used in order to produce such coating medium compositions.

The method according to the invention is a method for producing a coating medium composition usable in the automobile industry, or a precursor thereof. It comprises at least steps (1) to (6), but may also contain further optional steps. Preferably, steps (1) to (6) are carried out in this order.

The expression “by means of assistance by software”, which is used in particular in connection with steps (3), (5) and (6) of the method according to the invention, embraces preferably assistance by means of SAP-based (ERP) and/or Sybase-based (MES) software. Corresponding algorithms are preferably employed here. The software used preferably represents MES (Manufacturing Execution System) software. The term “software” represents at least one computer program. The formulae of the target formulation here are input preferably from a higher-level task system such as SAP, in the form of ERP software (Enterprise Resource Planning software), into the MES software. The formulae may alternatively and preferably be set up directly in the MES software, preferably within a formula database, and/or retrieved therefrom. In the latter case, therefore, the formulae are generated only within the MES software and are input as a task.

Step (1) of the Method According to the Invention

Step (1) provides creation of a formula of a target formulation, which corresponds to the coating medium composition to be produced, or the precursor thereof, or retrieval of such an existing formula from a database. In step (1) of the method, a formula of a target formulation, existing in electronic form, is preferably created or retrieved. Preferably, step (1) is therefore carried out electronically. Particularly preferably, the creation of the formula is carried out by means of software and the retrieval of an existing formula is carried out from an online database. Step (1) is therefore preferably carried out by means of assistance by software.

The formula of the target formulation comprises in particular the type, number and quantity of the components which are required in order to produce the target formulation, as well as the order in which they are added. Furthermore, the formula moreover comprises a predefined error tolerance range for each of the components used in order to produce the target formulation, in relation to its weighing-in quantity. This preferably quantity-specific error tolerance range is preferably assigned to the respective components in the formula. Moreover, this preferably quantity-specific error tolerance range may, with additional account taken of the accuracy of the weighing, be assigned specifically to each networked work-station, by way of parameter values. Moreover, each component used may additionally or alternatively have a substance-specific error tolerance assigned to it, preferably by means of a raw materials database. Which of the kinds of error tolerances is to be prioritized, i.e. whether the quantity-specific or the raw materials-specific error tolerance has priority, can be predetermined, defined preferably by way of the respective configuration and/or within the formula.

For each of the components which are weighed in in step (5) in order to produce the target formulation, the formula of the target formulation therefore contains a predefined error tolerance range in relation to its weighing-in quantity. These predefined error tolerance ranges are, as described, specific to the raw materials, i.e. they depend on the type of component respectively used. Furthermore, these error tolerance ranges, as described, depend on the level of the weighing-in quantity of the respective component. The number of tolerance specifications specific to the raw materials may be predefined variably. In the context of the present invention, different tolerance ranges may be assigned both to a raw material and to a group of raw materials of the same type. If no tolerances specific to the raw materials are stored in the database, the tolerance value ranges of the balance respectively used such as a network balance, which are to be specified in the database, preferably apply. The different tolerance ranges as a function of the weighing-in quantity may be specified both as absolute values and as relative values: for example, for weighing-in up to 50 g, the allowable tolerance may be given by an absolute specification instead of as a percentage, and for example for weighing-in up to 50 g the allowable tolerance may be ±0.1 g, while in a range of from 50 g to 100 g it may be ±0.5 g, and lastly in the case of an envisioned weighing-in quantity in a range of from 100 to 1000 g, a reasonable error tolerance range may be ±0.50 wt % relative. For weighing-in from 1000 g to 25000 g, further tolerance categories may be specified as absolute or relative specifications.

Lastly, the predefined error tolerance range, as described, must naturally be matched to the weighing accuracy of the balance used in step (5).

Preferably, the predefined error tolerance range, according to the experiences of the person skilled in the art of producing coating batches, is no more than ±1 wt %, particularly preferably no more than ±0.75 wt %, more particularly preferably no more than ±0.50 wt %, in each case expressed in terms of the total weighing-in quantity of an individual component.

In particular when the method according to the invention is carried out on the laboratory scale, the predefined error tolerance ranges are preferably in accordance with those error tolerance ranges which are subsequently applied for the individual components on the industrial scale. One advantage of the method according to the invention is therefore that upscaling method step to the subsequent production scale can be implemented substantially more easily, since by means of the method according to the invention implementation of these subsequent requirements is already carried out from an early stage during development at the research level.

Preferably, the formula of the target formulation, which formula is created or retrieved from a database according to step (1), is represented visually, for example on a touch panel or monitor.

Preferably, for all the components usable in order to produce the target formulation, the error tolerance ranges predefined in the formula may be retrieved from a database, such as an online database, and are integrated into the formula in step (1) of the method. This may be done by direct retrieval as part of an existing formula from a database. If a formula of a target formulation is created for the first time in step (1), this may be linked with an existing database, and predefined error tolerance ranges, already existing in this database, of the components used in the formula may be integrated into the new formula. The new formula, including the predefined error tolerance ranges of the components mentioned therein, may then in turn be integrated into the database.

Besides the type, number and quantity of the components which are required in order to produce the target formulation, as well as the order in which they are added and their respective predefined error tolerance ranges, the formula of the target formulation may also contain further information relating to the production of the target formulation, for example generally applicable, production-compliant and practice-compliant criteria such as peripheral speeds for stirring and mixing processes, which are to be followed during the stirring when mixing the components.

The peripheral speed specifications are, independently of the stirring mechanism and batch size of the laboratory scale, production parameters which may be applied directly for the upscaling method step to the production scale. Thus, the production of a target formulation while stirring may already be standardized at this time by means of such generally applicable relative production parameters, without in this case resorting only to stirring mechanism-specific specifications such as rpm (revolutions per minute), which only have validity for the respectively used stirring mechanism and the batch size in the laboratory.

Optional Step (1a) of the Method According to the Invention

Preferably, the method according to the invention furthermore comprises a step (1a), which is carried out after carrying out step (1) but before carrying out step (2), namely
(1a) applying a label to a container in which the target formulation is intended to be produced, the label containing the formula of the target formulation in electronically readable form.

The container is then the container used in step (2) of the method according to the invention.

The label is preferably electronically readable by means of a reading device suitable therefor, such as a scanner. Particularly preferably, the label constitutes a barcode. The label is preferably applied on the outside of the container. The container is preferably empty.

Step (2) of the Method According to the Invention

Step (2) provides provision of a container, which has a label that contains the formula of the target formulation in electronically readable form.

The container has a label, preferably on its outside. The label is preferably electronically readable by means of a reading device suitable therefor, such as a scanner. Particularly preferably, the label constitutes a barcode. The container is the container on which the aforementioned label is applied according to optional step (1a) of the method according to the invention. The container provided according to step (2) is preferably empty, and is in particular also empty before the start of carrying out step (5), in which it is used.

Step (3) of the Method According to the Invention

Step (3) provides electronic reading of the label of the container provided in step (2). Step (3) is carried out by means of assistance by software. This allows electronic reading of the label.

The electronic reading according to step (3) of the method according to the invention preferably involves scanning of the label located on the container. Preferably, a scanner is used for carrying out step (3). Step (3) is preferably carried out manually, particularly preferably by a laboratory coworker.

By the reading process according to step (3), the desired formula of the target formulation is preferably represented visually, preferably on a touch panel or monitor.

Step (4) of the Method According to the Invention

Step (4) provides provision of storage containers containing those components which are required according to the formula in order to produce the target formulation.

Preferably, each of the storage containers provided in step (4) of the method has an electronically readable label, which contains at least information about the type and quantity of the components respectively contained in the storage containers. Particularly preferably, these labels respectively constitute a barcode. The labels are preferably respectively applied on the outside of the respective storage container. The labels are preferably electronically readable by means of a reading device suitable therefor, such as a scanner.

Optional Step (4a) of the Method According to the Invention

Preferably, the method according to the invention furthermore comprises a step (4a), which is carried out after carrying out step (4) but before carrying out step (5), namely
(4a) electronically reading electronically readable labels, which are located on each of the storage containers provided according to step (4) and contain at least the information about the type and quantity of each of the components contained in the storage containers.

The electronic reading according to step (4a) of the method according to the invention preferably involves scanning of the labels located on the storage containers. Preferably a scanner is used for carrying out step (4a). Preferably, step (4a) is carried out manually, particularly preferably by a laboratory coworker.

By the reading process according to step (4a), at least information about the type and quantity of each of the components contained in the storage containers is preferably represented visually, preferably on a touch panel or monitor.

By the reading process according to step (4a), even before the weighing-in according to step (5), it is possible to check whether the correct components, or correct storage containers, required for the production of the target formulation are respectively being used. Incorrect weighing-in can be avoided in this way. It is also possible to check whether the respective storage container still contains a sufficient quantity of the respectively required component for the formula of the target formulation. Furthermore, it is possible to check whether the correct order of adding the components according to the formula has been complied with.

This check according to step (4a) is used to monitor the production method according to the invention. The check is preferably carried out by means of software, i.e. step (4a) is carried out by means of assistance by software.

Optional Step (4b) of the Method According to the Invention

Preferably, the method according to the invention furthermore comprises a step (4b), which is carried out after carrying out step (4) or (4a) but before carrying out step (5), namely
(4b) adapting the quantities, specified in the formula of the target formulation, of all the components required in order to produce the target formulation according to step (4), if at least one of the components is only available in a quantity less than that specified by the formula.

The information that at least one of the components is available only in a quantity less than that specified by the formula is preferably obtained by carrying out step (4a), for which reason step (4b) is preferably not carried out until after step (4a) has been carried out.

Step (5) of the Method According to the Invention

Step (5) provides weighing of the components provided in step (4) into the containers which are provided in step (2) and are suitable for weighing-in, the weighing-in of the components respectively being carried out in the quantities and order which are specified by the formula of the target formulation. Step (5) is carried out by means of assistance by software, this assistance comprising monitoring of the weighing-in according to step (5). Despite the assistance by software, however, the weighing-in per se is preferably carried out manually by a person such as a laboratory assistant.

The software-assisted conduct of step (5) of the method according to the invention allows automated monitoring of the weighing-in step (5). In step (5), the method according to the invention therefore allows automated monitoring of the weighing-in of those components which, according to the formula of the target formulation, are required in order to produce the latter. In particular on the basis of the specifications of the formula of the target formulation, in step (5) monitoring is carried out of whether the correct components are being used in the correct quantities and in the correct order. Since, for each of the components which is weighed in in step (5) in order to produce the target formulation, the formula of the target formulation contains a predefined error tolerance range in relation to its weighing-in quantity, the weighing-in of the components in step (5) can therefore furthermore be carried out in the scope of their respective predefined error tolerance ranges.

Preferably, the predefined error tolerance ranges for the weighing-in of the components in step (5) are already taken into account and fully exploited from the weighing-in of the first component, which is weighed in according to the formula in order to produce a target formulation, as a first position.

Preferably, the software-assisted monitoring of the weighing-in according to step (5) takes place at each instant during the conduct of step (5). The monitoring in this case comprises, in particular, monitoring of the respective quantities and the order of the weighing-in of the components according to the formula of the target formulation. Furthermore, the monitoring involves, in particular, monitoring of the compliance with the predefined error tolerance ranges in relation to the weighing-in quantities of the components.

The weighing-in according to step (5) is preferably carried out manually, for example by a person tasked therewith, such as a laboratory coworker.

Preferably, stirring of the weighed-in components is carried out during the weighing-in according to step (5) while complying with the target formulation.

The progress of the weighing-in and its monitoring according to step (5) are preferably represented visually. Preferably, the visual representation in this case comprises the weighing-in quantity of each of the components used at each instant during the conduct of step (5), and preferably furthermore involves display of the weighing-in quantity after weighing-in of each of the components has been carried out. Preferably, the visual representation furthermore comprises display of the error tolerance of each of the components, in relation to its respective target weighing-in quantity. The visualization is preferably respectively carried out on a touch panel or monitor. Preferably, in this case the respective weighing-in position is represented visually and both tolerance monitoring (for example in a range of ±1% for a particular component) and the manually weighing-in per se are managed by the software and marked in color. For example, the progress of the weighing-in and the monitoring of the weighing-in according to step (5) may be visualized by means of an optical and dynamic progress bar or arrow, in which case the current “actual” weighing-in is preferably also displayed besides the respective “setpoint” specification of the weighing-in. This bar or arrow grows with an increasing “actual” weighing-in during the weighing-in process. In addition, it changes its color from for example “yellow” (meaning: “setpoint” specification not yet reached) through “green” (meaning: “actual” weighing-in is within the range of the error tolerance of the “setpoint” specification) to “red” when exceeding this range of the error tolerance and therefore the “setpoint” specification. An optional addition having an acoustic signal recording, corresponding, for example, to PDC systems (Park Distance Control), is likewise possible.

Preferably, therefore, the progress of the weighing-in and the monitoring of the weighing-in according to step (5) are represented visually by displaying a dynamic progress bar or arrow which grows in the course of the conduct of step (5), and is preferably configured in color, the current “actual” weighing-in preferably also being displayed besides the respective “setpoint” specification of the weighing-in according to the formula of the target formulation of the weighing-in.

First monitoring of the correct component addition and component order is in this case preferably already carried out, as described above, in the additional optional step (4a), for example by means of a barcode scan of the labels applied on the respective storage containers: if, for example, scanning of an incorrect component (or of the correct component, but at the wrong position in the order of their addition according to the formula) takes place in step (4a), this is correspondingly represented visually (error dialog display, for example in the color red) and the respective coworker is thereby already made aware of their error before the weighing-in.

Step (6) of the Method According to the Invention

Step (6) provides creation of an electronic log at least relating to the weighing-in carried out according to step (5). The conduct of step (6) is carried out by means of assistance by software. This makes it possible to create the electronic log.

The log created according to step (6) preferably contains all the absolute quantity indications of the weighing-in carried out according to step (5), including specifications of the range in which the respective error tolerance ranges of the individual components have been complied with.

The log is preferably created automatically immediately after the end of production, i.e. after weighing-in has been carried out according to step (5), is retrievable and can subsequently be inspected at any time. Preferably, the log created in this way is in this case integrated directly into a database, preferably an online database, which is preferably the same database as may be accessed in step (1), or the log is automatically transmitted to the higher-level commissioning ERP system.

Step (7) of the Method According to the Invention

The method according to the invention furthermore comprises a step (7), which is carried out after carrying out step (6), namely
(7) creating an electronic documentation of the entire production process of the coating medium composition or the precursor thereof.

Preferably, the documentation created in step (7) contains indications as to what extent and in what measure all specifications contained in the formula of the target formulation have been satisfied.

Preferably, the documentation created in step (7) represents a systematic digital documentation of the entire production method, and is retrievable at any time. Especially in the course of a succession of series of tests in the development of coating medium compositions and precursors thereof, this systematization offers a significant improvement in relation to the result prediction and outcome reliability.

The consumption and the resulting current stock of the quantities of all components used in order to produce the target formulation are also recorded, documented and managed in the documentation created in step (7). The consumption and the resulting current stock of the quantities of those components which are contained in the storage containers used in step (4) of the method are therefore recorded and documented and managed in the documentation created in step (7).

On the basis of this recording and documentation in step (7), after a critical stock quantity of a component is reached, it is possible to schedule or carry out ordering and/or requesting of further quantities of the respective component promptly for the purpose of replenishing the stock of these components.

In particular, step (7) of the method according to the invention makes it possible to make possible influences by particular components used for production of the target formulation trackable, for example when using defective batches of a raw material. The batches may be traced back and tracked in the context of quality assurance, quality management and the corresponding audit conformities.

Furthermore, step (7) of the method according to the invention makes it possible to set up software-assisted stock management and stock organization, which may be carried out online, and by means of which the stock of all components used for the production of target formulations can be managed and organized.

In particular when the documentation created according to step (7) furthermore records and documents the consumption and the resulting current stock of the quantities of all components used in order to produce the target formulation, it is thereby possible that the supply management of the stock, which is responsible for ensuring constant availability of all required raw materials, can be carried out proactively and immediately after reaching a particular critical stock quantity. Bottlenecks and therefore delays during production of the target formulations can thereby be avoided. Furthermore, oversupply (i.e. too large a quantity) of particular raw materials can be avoided, which would otherwise require additional storage space (and therefore undesired investments). Additionally, with a preferably actively managed stock management system, the inevitable exceedance of the shelf life of overstocked raw materials of which too much has been ordered, and the associated additional raw materials costs, are prevented. These disadvantages are avoided when the raw material consumption is recorded in the course of the software-assisted and documented weighing-in, in order to carry out automated stock management and laboratory raw material demand planning with the software-assisted solution. Step (7) thus allows automated stock management of the laboratory raw material supply and proactive ordering processes after reaching critical stock quantities (minimum stock) of the components. The reaching of such critical stock quantities then preferably leads automatically to initiation of the necessary reordering processes, so that raw material bottlenecks and stoppages during the production of target formulations are avoided, since it is often found only during weighing-in that particular raw material quantities are coming to the end and raw material reprocurement measures are only then initiated at this late time.

In particular when the documentation created according to step (7) furthermore records and documents the consumption and the resulting current stock of the quantities of all components used in order to produce the target formulation, the method according to the invention in this way allows batch tracing of the raw materials used. In the case of conventional production and weighing-in methods, this is often associated with not inconsiderable extra outlay. The printed test table (i.e. specification of the weighing-in until the target formulation is reached) in paper form, which is associated with the analog working procedure, would, besides the checking off of the weighed-in positions, additionally require a note of the respective batch number. Since this form is usually required only for the production method of the target formulation, and is then disposed of, the noted data would need to be transferred into the test tables in a second step. This procedure is time-intensive, and possibly required evaluation would likewise need to be carried out by hand. Possible copying errors of long batch numbers may make this more difficult or even impossible. Step (7) thus allows automated batch documentation, which is a significant advantage above all in the course of prolonged development, for example in order to be able to unambiguously investigate and study unusual effects or test results, specifically also at a later time after the target formulation has already been produced. The readjustment of defective target formulations, by once more producing the coating system in the laboratory in an identical way with all the raw material batches used in production for this formulation, has to date also been possible only with considerable raw material organization outlay because of the purely analog oversight. By means of the method according to the invention, and in particular step (7), however, for the first time the requirement for batch tracing can be comprehensively satisfied even in the production of target formulations in the laboratory.

Optional Step (8) of the Method According to the Invention

Preferably, the method according to the invention furthermore comprises an optional step (8), which is carried out after carrying out step (7), namely
(8) integrating the electronic documentation created according to step (7) into software-assisted stock management and storage organization relating to all components used for production of the target formulation, which is preferably carried out online.

Optional step (8) of the method according to the invention allows management and/or organization of the stock of all components used for production of the target formulation. In this way, after reaching a critical stock quantity of a component, the ordering and/or requesting of further quantities of the respective component for the purpose of replenishing the stock of these components can be scheduled or carried out promptly.

Coating Medium Compositions and Precursors Thereof

The method according to the invention is a method for producing a coating medium composition usable in the automobile industry, or a precursor thereof.

Coating medium compositions usable in the automobile industry are, as already mentioned above, for example electro-dip coatings, primers (priming surfacers), fillers, base coats, in particular water base coats, top coats, including clear coats, in particular solvent-based clear coats.

The term base coat is known to the person skilled in the art, and is defined for example in the Römpp Lexikon, Lacke and Druckfarben [Römpp Lexicon of Coatings and inks], Georg Thieme Verlag, 1998, 10^{th} edition, page 57. A base coat is therefore intended, in particular, to mean an intermediate coating material which provides coloring, and/or provides coloring and imparts an optical effect, used in automobile coating and general industrial coating. It is generally applied on a metal or plastic substrate pretreated with fillers or primers, sometimes even directly on the plastic substrate. Old coatings, which may possibly also need to be pretreated (for example by grinding), may also be used as substrates. By now, it is entirely usual to apply more than one base coat layer. Correspondingly, in such a case a first base coat layer constitutes the substrate for a second. In order to protect a base coat layer particularly against environmental influences, at least one additional clear coat layer is also applied thereon.

A precursor of a coating medium composition usable in the automobile industry is preferably a pigment paste and/or filler paste. The term pigment paste in this case covers colored pigment pastes and effect pigment pastes. Precursors furthermore comprises (temporary) semifinished products, which may be used in order to produce such coating medium compositions, in particular base coats such as water base coats. Such temporary semifinished products are also referred to as so-called “partial weigh-ins” (PWI).

The term “filler” is known to the person skilled in the art, for example from DIN 55943 (date: October 2001). A “filler” in the context of the present invention is preferably intended to mean a component which is essentially, preferably fully, insoluble in the application medium, and which is used in particular to increase the volume. Preferably, “fillers” in the context of the present invention differ from “pigments” by their refractive index, which for fillers is <1.7. Examples of suitable fillers are kaolin, dolomite, calcite, chalk, calcium sulfate, barium sulfate, graphite, silicates such as magnesium silicates, in particular corresponding sheet silicates such as hectorite, bentonite, montmorillonite, talc and/or mica, silicas, in particular fumed silicas, hydroxides such as aluminum hydroxide or magnesium hydroxide, or organic fillers such as textile fibers, cellulose fibers, polyethylene fibers or polymer powders; reference is furthermore made to the Römpp Lexikon Lacke and Druckfarben, Georg Thieme Verlag, 1998, pages 250 ff., “Fillers”.

The term “pigment” is likewise known to the person skilled in the art, for example from DIN 55943 (date: October 2001). A “pigment” in the context of the present invention is preferably intended to mean components in powder or platelet form which are essentially, preferably fully, insoluble in the medium enclosing them. These are preferably colorants and/or substances which may be used as a pigment because of their magnetic, electrical and/or electromagnetic properties. Pigments preferably differ from “fillers” by their refractive index, which for pigments is ≥1.7. Colored pigments and/or effect pigments may be used as pigments. The terms “coloring pigment” and “colored pigment” are interchangeable. Inorganic and/or organic pigments may be used as a colored pigment. Preferably, the colored pigment is an inorganic colored pigment. White pigments, color pigments and/or black pigments are used as particularly preferred colored pigments. Examples of white pigments are titanium dioxide, zinc white, zinc sulfide and lithopones. Examples of black pigments are carbon black, iron-manganese black and spinel black. Examples of color pigments are chromium oxide, chromium oxide hydrate green, cobalt green, ultramarine green, cobalt blue, ultramarine blue, manganese blue, ultramarine violet, cobalt violet and manganese violet, iron oxide red, cadmium sulfoselenide, molybdate red and ultramarine red, iron oxide brown, mixed brown, spinel and corundum phases and chromium orange, iron oxide yellow, nickel titanium yellow, chromium titanium yellow, cadmium sulfide, cadmium zinc sulfide, chromium yellow and bismuth vanadate.

The term pigment paste is known to the person skilled in the art, and is defined for example in the Römpp Lexikon, Lacke and Druckfarben, Georg Thieme Verlag, 1998, 10^{th} edition, page 452: pigment pastes are preparations of pigment mixtures in carrier materials, such as polymers, in which the pigments are present in a concentration higher than corresponds to the subsequent application. The subsequent application of pigment pastes is generally in the production of coating medium compositions such as base coats. A pigment paste is therefore to be distinguished from a coating medium composition, such as a base coat, in that it merely represents a precursor for the production of such a coating medium composition. A pigment paste per se cannot therefore itself be used as a base coat. In pigment pastes, the relative weight ratio of pigments to polymers is usually greater than in the coating media, for the production of which the paste is ultimately used.

Besides the carrier materials such as polymers, which are also referred to as paste binders, and pigments, water and/or organic solvents are usually contained in the pigment paste. Various additives, such as wetting agents and/or thickeners, may also be used in a pigment paste.

An effect pigment paste represents a pigment paste which contains at least one effect pigment as pigment. A person skilled in the art is familiar with the term effect pigments. A corresponding definition is for example found in the Römpp Lexikon, Lacke and Druckfarben, Georg Thieme Verlag, 1998, 10^{th} edition, pages 176 and 471. A definition of pigments in general, and further specifications thereof, are set out in DIN 55943 (date: October 2001). Effect pigments are preferably pigments that impart an optical effect, or impart a colored and optical effect, in particular impart an optical effect. The terms “pigment which imparts an optical effect and imparts color”, “pigment which imparts an optical effect” and “effect pigment” are therefore preferably interchangeable. Preferred effect pigments are, for example, metal effect pigments in platelet form, such as aluminum pigments in platelet form, gold bronzes, heat-treated bronzes and/or iron oxide-aluminum pigments, pearlescent pigments such as pearl essence, basic lead carbonate, bismuth oxide chloride and/or metal oxide-mica pigments (mica) and/or other effect pigments, such as graphite in platelet form, iron oxide in platelet form, multilayer effect pigments of PVD films and/or liquid-crystal polymer pigments. Effect pigments in platelet form are particularly preferably contained in the pigment paste, in particular aluminum pigments in platelet form and metal oxide-mica pigments.

Pigment pastes usually contain at least one pigment paste binder (paste binder). The term “binder” in the context of the present invention, in accordance with DIN EN ISO 4618 (German version, date: March 2007) is preferably intended to mean the nonvolatile fractions, responsible for film binding, of a composition with the exception of the pigments and/or fillers contained therein. The nonvolatile fraction may be determined according to the method described below. A binder component is consequently a particular component which contributes to the binder content of a composition.

Water Base Coats Producible by Means of the Method According to the Invention

The coating medium composition producible by means of the method according to the invention is preferably a base coat, in particular an aqueous base coat (water base coat).

Both on the production scale and on the laboratory scale in the course of the development thereof, water base coats require adaptation and improvement of so-called partial weigh-ins: this means that not all the formula constituents can be weighed together successively into a container such as a mixing vessel, but must be available as prefabricated partial mixtures for different chronological position additions. On the production scale, the term prebatching is used in this context, and in the laboratory also partial weigh-ins. Such partial weigh-ins represent temporary semifinished products and therefore precursors of coating medium compositions in the context of the present invention. The reason for using the partial weigh-ins is that the raw materials of the water base coats represent both hydrophilic (polar) and hydrophobic (nonpolar) components. These may exhibit incompatibilities and demixing with respect to one another. Premixtures and orders of addition etc. are therefore to be complied with.

If the method according to the invention is used in order to produce such a partial weigh-in as a precursor for the production of a water base coat, then according to step (6) a corresponding log relating to the weighing-in carried out is created, and according to optional step (7) electronic documentation of the entire production method is also created, which preferably contains not only indications as to what extent and in what measure all specifications contained in the formula of the target formulation have been satisfied, but in which the consumption and the resulting current stock of the quantities of all components used for production of the target formulation are preferably also recorded and documented. Furthermore, the information about the production of these precursors which has been carried out may be incorporated into a database, preferably the one in which the formulae of the target formulations are contained.

By such a “store acknowledgement” of the precursors produced after their production with software assistance the availability of these precursors in the corresponding quantity and at the necessary time may be checked and ensured, and in the event of corresponding quantity stocking of the precursors beyond the demand of the present formula of the target formulation, the remaining quantity of the precursors produced in this way may be promptly planned in for future reuse in a subsequent target formulation, and it is therefore possible to avoid repeated manufacture of these precursors for subsequent target formulations.

A water base coat formula usually consists of up to 30 individual positions, i.e. 30 components are required in order to produce the water base coat. Some of the positions are present in a main mixing vessel, such as the container which was mentioned in steps (2) and (5) of the method and is used as a “master vessel”. For example, positions 1 to 5 of the formula may be present, or weighed in, in this container. The further positions 6 to 15 and 16 to 28, on the other hand, are respectively weighed in first in a separate container, used as an auxiliary vessel, beforehand in order to produce two mutually different precursors (precursor 1: positions 6 to 15; precursors 2: positions 16 to 28). These two precursors 1 and 2 are then added in this order to the master vessel, which already contains positions 1 to 5 of the formula. Subsequently, positions 29-30 of the formula are in turn regularly added after addition of the two precursors 1 and 2. Precursors produced by means of the method according to the invention may therefore after their production be used again as starting components for the coating medium composition to be produced.

In other words, the container obtained after step (5) of the method according to the invention, which contains a precursor produced by means of the method according to the invention, may in turn be used following step (4) as a storage container for the production of another target formulation, or subsequent target formulation. In this case, the target formulation which is held in the container, and is available after step (5), is thus preferably at least one precursor for the production of a coating medium composition, and it is used after its production in step (4) as a component, contained in a storage container, for the production of a coating medium composition. This is advantageous, as mentioned above, particularly for the production of water base coats. After production of a precursor for the production of a coating medium composition according to step (5), the method according to the invention may therefore preferably be carried out again in this case, the precursor obtained after the first run being used in the second run as a starting component in step (4). Correspondingly, the container obtained after step, which contains the precursor as a target formulation, is used in the second run as a storage container in step (4).

In this case, in the method according to the invention, it is preferably ensured that the respectively required quantities of precursors thus produced in step (5) are available in sufficient quantity at the necessary time according to their position order, so that they can in turn be used again as components in step (4) of the method. This is preferably achieved by means of carrying out step (6) and optionally step (7), and incorporating into the database the documentation relating to the production carried out of the precursors. This information may then be stored in such a way that it can be retrieved for future subsequent tasks (production of further target formulations).

Furthermore, in the method according to the invention it is preferably ensured (preferably by step (7) that the stocking up of the quantities of available precursors is carried out automatically and to a sufficient extent, since during the software-assisted weighing-in according to step (5), by using storage containers according to step (4) which contain these precursors, losses may occur because of the not 100% residue-free decanting into the containers in step (5). It is therefore preferably ensured that a somewhat larger quantity of the precursors must always be available than is actually required in order to produce the coating medium composition.

Furthermore, by means of the method according to the invention, in many cases a reduction of the total running time can be achieved, i.e. the time required to produce a coating medium composition, by the production of a target formulation which represents a coating medium composition, for the production of which at least one precursor is required, is carried out by a plurality of persons in parallel by means of the method according to the invention. This may be achieved in that a coating medium composition, and the precursors required therefor, are formulated as separate formulae for the production of mutually different target formulations. In this case, the matching previously required therefor, and error frequency for the combination of all these precursors in one main task (production of the coating medium composition) are avoided. After step (3) of the method according to the invention has been carried out, it is thus possible to monitor whether all components required for the coating medium composition as a target formulation are present, and in optional step (4a) it is possible to evaluate whether there is a sufficient quantity of required precursors. For example, considering the aforementioned example, A and B coworkers in parallel may respectively produce one of precursors 1 and 2 (precursor 1: positions 6 to 15 of the base coat; precursor 2: positions 16 to 28 of the base coat), since in the method according to the invention these respectively represent separate formulae for the production of a target formulation. In parallel therewith, coworker C makes the base coat consisting of 30 positions, and to this end uses precursors 1 and 2 as soon as they are available.

Solvent-Based Clear Coats Producible by Means of the Method According to the Invention

Preferably, the coating medium composition producible by means of the method according to the invention is a clear coat, in particular a solvent-based clear coat.

In contrast to water base coats, solvent-based clear coats do not usually require so-called partial weigh-ins. Nevertheless, just like water base coats, clear coats often contain up to 30 or more individual positions. In contrast to water base coats, however, in the case of clear coats the sample production is usually carried out completely chronologically, i.e. as serial weighing-in in only one container in step (5). The wet chemical structure of solvent-based coat systems, such as corresponding clear coats, is based on hydrophobic and correspondingly nonpolar feed material components. These raw materials, because of their similarity, are usually unlimitedly miscible with one another. Nevertheless, for the purpose of increasing efficiency and shortening the production method, it is also advantageous to carry out the production of clear coats in the same way as described above, i.e. by means of separate formulae of a plurality of (artificial) precursors, even if this is not needed in terms of coating chemistry, which are then finally combined in order to produce the clear coat.

For example, a formula of a target formulation for the production of a clear coat, which comprises 30 positions, may be divided into three separate formulae of target formulations, respectively for the production of a precursor comprising 10 positions. This may be carried out in parallel by 3 coworkers. The three precursors produced in this way, each with ten positions, are then in turn combined in a final special recombination step in an empty container (master vessel). The procedure for the above-mentioned partial weighing-in processes for water base coats may thus also be used similarly even for tasks without actually required partial weigh-ins, in order to increase efficiency by means of split tasks.

This applies all the more when, for example, entire series of tests are intended to be produced. Even in the case of 10 different clear coats to be produced, each with 25 components, despite variations in the composition of the components and their quantities, there are usually still correspondences within these 10 formula columns, so that, for example, restriction to a total of eight formula columns with five positions is possible, so that the production method can be rendered more efficient. Thus, a common partial weigh-in may be produced from these five positions. Instead of the otherwise required 40 individual weighing-ins, the weighing-in steps can thus be reduced to five for the production of the partial weigh-ins plus eight for the addition of these partial weigh-ins to the batches.

Further Coating Medium Compositions Producible by Means of the Method According to the Invention

As mentioned above, by means of the method according to the invention an entire range of coating medium compositions usable in the automobile industry may be produced, for example electro-dip coatings, primers (priming surfacers), fillers, base coats, top coats, including clear coats.

While the aforementioned water base coats and clear coats are examples of pure mixing production, for example with stirring machines, the production of e.g. fillers and electro-dip coatings requires so-called mill abrasion or dispersion processes. In order to produce target formulations in the laboratory or in production, a dissolver batch is usually produced first (a dissolver is a special stirring machine for the purpose of predispersion of solids in binders).

For the production of coating medium compositions which require dispersion processes, for example by using horizontal mills, the mixture of components which is used for production is usually first finely dispersed by means of a horizontal mill to the desired grain fineness. The batch quantity before the mill (dissolver batch) may differ greatly from the resulting quantity after the mill abrasion process (the ground material). This is related to not exactly calculable losses during the grinding process. The subsequent finishing of the ground material by adding the final constituents is referred to as completion. The individual material additions during the completion must be matched by calculation beforehand to the quantity of the resulting ground material. For this reason, the use of partial weigh-ins for the production of such coating medium compositions by means of the method according to the invention is also advantageous in this case.

Usually, a percentage reduction in relation to the completion material is necessary. As a function of the sample calculation, however, for a required fixed final quantity, stocking up of the corresponding individual material additions, and thus ultimately of the ground material, may also be necessary. A corresponding calculation task adaptation when using the method according to the invention is therefore advantageous in this case.

This will be illustrated by the following example: the ground material, which is used in order to produce a filler as a coating medium composition, represents a precursor in the context of the present invention. Before or after production of this ground material, the possibility of stocking up or reduction may be applied. In step (1) of the method, a formula is formulated, according to which 5000 g of a filler are intended to be produced. The proportion of the partial weigh-in of the ground material batch out of the dissolver batch (before grinding loss) is 50 parts by weight of 100 parts by weight. In the case of a target quantity of 5000 g, this corresponds to 2500 g. After the grinding process, however, the yield of the ground material is merely 2000 g because of abrasion losses. In the formula of the target formulation (completion fractions), this ground material appears as a precursor in the form of an individual position. If the underlying 100 parts formula of this main task of the target formulation appears as follows, the SETPOINT/ACTUAL recalculation process represented below is necessarily entailed in order to ensure that the formula fractions remain constant with respect to one another as planned by the formula in spite of grinding loss:

| | | | | | ACTUAL | |
|---|---|---|---|---|---|---|
| | | | | | partial weigh-in/ | |
| | SETPOINT | | | | recalculation | |
| Pos. 1 ground | 50 | parts= | 2500 | g= | 2000 | g (−500 g) |
| material | | | | | | |
| Pos. 2 binder | 30 | parts= | 1500 | g= | 1200 | g (factor 0.8) |
| Pos. 3 solvent | 10 | parts= | 500 | g= | 400 | g |
| Pos. 4 additives | 10 | parts= | 500 | g= | 400 | g |
| Sample total | 100 | parts= | 5000 | g= | 4000 | g OK |

This automatic recalculation function after input of the resulting ACTUAL quantity of the partial weigh-in ground material is thus preferably to be taken into account.

This is made possible by carrying out optional step (4b), which provides adaptation of the quantities, specified in the formula of the target formulation, of all the components required in order to produce the target formulation according to step (4), if at least one of the components is only available in a quantity less than that specified by the formula.

Conversely, the quantities specified in a target formulation may naturally be stocked up if the quantity specified therein is too low. In the present example, the corresponding batch quantities, i.e. first all the partial weigh-in (PWI)-relevant ground material components may be correspondingly increased, preferably by means of a function in the software, for example here from 2500 g to 3000 g of yield after the abrasion process. According to the pattern of this resulting quantity (3000 g) of ground material, the remaining fractions of the completion are also automatically stocked up accordingly. Despite the very simple calculation operations, the automatic recalculation function saves time, and serves primarily to prevent calculation errors which would necessitate expensive re-production.

| | | | | | ACTUAL | |
|---|---|---|---|---|---|---|
| | SETPOINT | | | | PWI stock-up/Recalc. | |
| Pos. 1 ground | 50 | parts= | 2500 | g= | 3000 | g (+500 g |
| material | | | | | | increased yield) |
| Pos. 2 binder | 30 | parts= | 1500 | g= | 1800 | g (factor 1.2) |
| Pos. 3 solvent | 10 | parts= | 500 | g= | 600 | g |
| Pos. 4 additives | 10 | parts= | 500 | g= | 600 | g |
| sample total | 100 | parts= | 5000 | g= | 6000 | g OK |

### EXAMPLES AND COMPARATIVE EXAMPLES

The following examples and comparative examples serve to explain the invention, but are not to be interpreted as restrictive.

Unless otherwise mentioned, specifications in parts are parts by weight and specifications in percentages are respectively percentages by weight.

### 1. Comparative Example C1

A coating is intended to be produced by mixing together the following components while taking the following specifications into account (target formulation):

Component 1: 3000.0 g mixed coating (colorless)

Component 2: 450.0 g colored paste (white)

Component 3: 30.0 g colored paste (black)

Component 4: 5.0 g colored paste (red)

In this case, the individual components for production of the coating are weighed out successively. The balance used in this case is a conventional laboratory balance, which has a resolution of 0.01 g.

An error tolerance of ±1% for the weighing-in is in this case acceptable. In relation to the respective target specifications, weighing-ins which lie in the following ranges are therefore acceptable for components 1 to 4:

Component 1: 2970.0 g to 3030.0 g

Component 2: 445.5 g to 454.5 g

Component 3: 29.7 g to 30.3 g

Component 4: 4.95 g to 5.05 g

Usually, the coworker tasked with producing the coating, and therefore with weighing the aforementioned components in, endeavors to weigh in the components respectively in a quantity which corresponds as exactly as possible to the target formulation. Besides the resolution of the balance used, further factors have a limiting effect in this case, such as environmental influences (air draft, shaking, etc.) and furthermore the expertise of the respective coworker. Because of these factors, weighing-in which corresponds exactly to the specifications of the target formulation does not usually take place. This has, in particular, a relatively large effect for those components which are weighed in in relatively small quantities (in the present example components 3 and 4). On the other hand, in the case of components which are weighed in in relatively large quantities (in the present example components 1 and 2), the real result of the weighing-in is relatively accurate and quite close to the respective specifications.

In the present comparative example, components 1 to 4 are weighed in in the following quantities:

Component 1: 3000.3 g mixed coating (colorless)→acceptable (OK)

Component 2: 449.7 g colored paste (white)→OK

Component 3: 30.3 g colored paste (black)→OK

Component 4: 5.1 g colored paste (red)→not OK

For the weighing-in of components 3 and 4, the percentage deviation in relation to the target specification is greater than in the case of components 1 and 2. The weighing-in of components 3 and 4 is therefore more inaccurate than that of components 1 and 2. In fact, it is not possible for the respective coworker to weigh in relatively smaller positions with the same accuracy.

In the present case, the deviations from the target specifications for components 1 and 2 are acceptable, and just still acceptable for component 3. The weighing-in of component 4, however, is too inaccurate since it lies outside the tolerance range.

### 2. Example E1

The advantage of the software-assisted manual weighing-in according to step (5) of the method according to the invention is—in relation to the components 1 to 4 which were used in Comparative Example C1 above—that the allowable error tolerance for the weighing-in is already taken into account from the first two positions (components 1 and 2), and therefore counter to the desire for maximum possible accuracy.

For the software-assisted manual weighing-in, the range of the error tolerance ±1% is already taken into account systematically from the first position (component 1), specifically already at the time at which a value of 2970 g is reached in the present example when weighing-in component 1, since this already lies within the range of the error tolerance for component 1: here, the coworker tasked with the weighing-in is already shown, after the time when this weighing-in of 2970 g is reached, that this value is “acceptable (OK)”. The weighing-in of component 1 may therefore already be ended at this time.

The software-assisted manual weighing-in of the following positions (components 2 to 4) is carried out in the same way, i.e. the coworker is already shown, after the respective range of the error tolerance limit of each of these components is reached, that the respective value is “acceptable (OK)”. This display of an “OK” message may be reinforced visually, for example by representing an optical and dynamic progress bar on a touch panel, this bar also showing the current “actual” weighing-in besides the respective “setpoint” specification of the weighing-in. This bar grows with increasing “actual” weighing-in during the process of weighing-in. In addition, it changes its color from for example “yellow” (meaning: “setpoint” specification not yet reached) through “green” (meaning: “actual” weighing-in is within the range of the error tolerance of the “setpoint” specification) to “red” when this range of the error tolerance, and therefore the “setpoint specification” is exceeded.

The advantage of this type of software-assisted manual weighing-in resides in the systematically representable and correspondingly practically implementable accuracy of the weighing-in. In addition, it is ensured in this way that even at the level of weighing-in for laboratory tests, the error tolerances of the weighing-in, which are categorically necessary later during industrial manufacture of such coating formulae, are already taken into account to a sufficient extent.

With the aid of this software-assisted manual weighing-in, in this way components 1 to 4 are weighed in in the following quantities in the present Example 1 and the relative weight ratio of the components to one another is maintained:

Component 1: 2974.1 g mixed coating (colorless)→acceptable (OK)

Component 2: 448.2 g colored paste (white)→OK

Component 3: 29.9 g colored paste (black)→OK

Component 4: 5.00 g colored paste (red)→OK

By way of example:

Setpoint component 1:3000.0 g to component 4:5.00 g=ratio 600:1

Actual component 1:3000.3 g to component 4:5.10 g=ratio 588:1

Actual component 1:2974.1 g to component 4:5.00 g=ratio 595:1.

1. A method for producing a coating medium composition usable in the automobile industry, or a precursor thereof, the method comprising:
(1) creating a formula of a target formulation, which corresponds to the coating medium composition to be produced or the precursor thereof, or retrieving such an existing formula from a database,
(2) providing a container, which has a label that contains the formula of the target formulation in electronically readable form,
(3) electronically reading the label of the container provided in step (2),
(4) providing storage containers containing components which are required according to the formula in order to produce the target formulation,
(5) weighing the components provided in step (4) into the containers which are provided in step (2) and are suitable for weighing-in, the weighing-in of the components respectively being carried out in quantities and order which are specified by the formula of the target formulation,
(6) creating an electronic log at least relating to the weighing-in carried out according to step (5), and
(7) creating an electronic documentation of an entire production process of the coating medium composition or the precursor thereof after carrying out step (6), wherein consumption and resulting current stock of quantities of all components used in order to produce the target formulation are also documented and managed in the electronic documentation created in step (7),
characterized in that at least steps (3), (5), and (6) are carried out by means of assistance by software, this assistance comprising monitoring of the weighing-in according to step (5), the formula of the target formulation containing, for each of the components which is weighed-in in step (5) in order to produce the target formulation, a predefined error tolerance range in relation to its weighing-in quantity, and the weighing-in of the components in step (5) is therefore carried out in a scope of the predefined error tolerance ranges.

2. The method as claimed in claim 1, characterized in that the method is used in laboratories for development of coating medium compositions usable in the automobile industry, or precursors thereof.

3. The method as claimed in claim 1, characterized in that the monitoring of the weighing-in assisted by software according to step (5) comprises monitoring of the quantities and order of the weighing-in of the components according to the formula of the target formulation, as well as of compliance with the predefined error tolerance ranges.

4. The method as claimed in claim 1, characterized in that the predefined error tolerance ranges in the formula for all the components usable in order to produce the target formulation can be retrieved by means of a database, and are integrated into the formula in step (1) of the method.

5. The method as claimed in claim 1, characterized in that each of the storage containers provided in step (4) of the method has an electronically readable label, which contains at least information about type and quantity of the components respectively contained in the storage containers.

6. The method as claimed in claim 1, the method further comprising:
(4a) electronically reading electronically readable labels, which are located on each of the storage containers provided according to step (4) and contain at least the information about type and quantity of each of the components contained in the storage containers,
wherein step (4a) is carried out after step (4) and before step (5).

7. The method as claimed in claim 1, the method further comprising:
(4b) adapting the quantities, specified in the formula of the target formulation, of all the components required in order to produce the target formulation according to step (4), if at least one of the components is only available in a quantity less than that specified by the formula,
wherein step (4b) is carried out after step (4) and before step (5).

8. The method as claimed in claim 1, characterized in that progress of the weighing-in and the monitoring of the weighing-in according to step (5) are represented visually.

9. The method as claimed in claim 1, characterized in that progress of the weighing-in and the monitoring of the weighing-in according to step (5) are represented visually by displaying a dynamic progress bar or arrow which grows in a course of step (5).

10. The method as claimed in claim 1, characterized in that the predefined error tolerance ranges for the weighing-in of the components in step (5) are already taken into account and exploited starting from the weighing-in of a first component, which is weighed in according to the formula in order to produce a target formulation as a first position.

11. The method as claimed in claim 1, characterized in that the electronic log created according to step (6) contains all absolute quantity indications of the weighing-in carried out according to step (5), including specifications of a range in which the predefined error tolerance ranges of the individual components have been complied with.

12. The method as claimed in claim 1, characterized in that the electronic documentation created in step (7) contains indications as to what extent and in what measure all specifications contained in the formula of the target formulation have been satisfied.

13. The method as claimed in claim 1, characterized in that the target formulation contained in the container, which is available after step (5), constitutes at least a precursor for the production of a coating medium composition, and is used after its production in step (4) as a component, contained in a storage container, for the production of a coating medium composition.

14. The method as claimed in claim 1, characterized in that the electronic documentation created in step (7) is a systematic digital documentation of an entire production method, and is retrievable at any time.

15. The method as claimed in claim 1, the method further comprising:
(8) integrating the electronic documentation created according to step (7) into software-assisted stock management and storage organization relating to all components used for production of the target formulation,
wherein step (8) is carried out after step (7).

16. The method as claimed in claim 9, wherein the dynamic progress bar is configured in color.

17. The method as claimed in claim 9, wherein a current “actual” weighing-in is displayed besides a respective “setpoint” specification of the weighing-in according to the formula of the target formulation of the weighing-in.
